(19) United States
(12) Patent Application Publication
(10) Pub. No.: US 2018/0304962 A1
(43) Pub. Date: Oct. 25, 2018

(54) BRAKE FLUID PRESSURE CONTROL UNIT AND BRAKE SYSTEM FOR MOTORCYCLE

(71) Applicant: Robert Bosch GmbH, Stuttgart (DE)

(72) Inventors: Eiji Adachi, Kanagawa (JP); Hiroaki Atsushi, Kanagawa (JP)

(21) Appl. No.: 15/771,055

(22) PCT Filed: Nov. 3, 2016
(86) PCT No.: PCT/IB2016/056601

§ 371 Date: Apr. 25, 2018

(30) Foreign Application Priority Data
Nov. 9, 2015 (JP) 2015-219683

(51) Int. Cl. B62L 3/08; B60T 13/68; B62L 3/02; B62L 3/04

(52) U.S. Cl. CPC B62L 3/08; B60T 13/686; B60T 8/3225; B62L 3/04; B60T 2270/10; B62L 3/023

(57) ABSTRACT

A brake fluid pressure control unit that can improve installability of a brake system in a motorcycle is obtained. A brake system for a motorcycle that includes such a brake fluid pressure control unit is also obtained.

A brake fluid pressure control unit 50 includes: a first primary base body 31 provided with an inlet valve 21 and an outlet valve 22 of a first hydraulic circuit 2; a first secondary base body 32 provided with a pressurizing/transferring mechanism 25 of the first hydraulic circuit 2; a second primary base body 33 provided with an inlet valve 21 and an outlet valve 22 of a second hydraulic circuit 3; and a second secondary base body 34 provided with a pressurizing/transferring mechanism 25 of the second hydraulic circuit 3, and the first primary base body 31, the first secondary base body 32, the second primary base body 33, and the second secondary base body 34 are separated.

### BACKGROUND OF THE INVENTION

The invention relates to a brake fluid pressure control unit of a brake system for a motorcycle and a brake system for a motorcycle, the brake system including the brake fluid pressure control unit.

As a conventional motorcycle (a two-wheeled motor vehicle or a three-wheeled motor vehicle), a motorcycle that includes a brake system having: a first hydraulic circuit that acts on a front wheel of the motorcycle; and a second hydraulic circuit that acts on a rear wheel of the motorcycle is available. Each of the first hydraulic circuit and the second hydraulic circuit includes: a primary channel that communicates between a master cylinder and a wheel cylinder; and a secondary channel that releases a brake fluid in the primary channel.

For example, a brake fluid pressure control unit is configured by including: an inlet valve that is provided in each of the primary channel of the first hydraulic circuit and the primary channel of the second hydraulic circuit; an outlet valve that is provided in each of the secondary channel of the first hydraulic circuit and the secondary channel of the second hydraulic circuit; a pressurizing/transferring mechanism that is provided on each of a downstream side of the outlet valve in the secondary channel of the first hydraulic circuit and a downstream side of the outlet valve in the secondary channel of the second hydraulic circuit; and a base body that is provided with those components. The pressurizing/transferring mechanism pressurizes and transfers the brake fluid in the secondary channel. In the brake fluid pressure control unit, operations of the inlet valves and the outlet valves and operations of the pressurizing/transferring mechanisms are controlled, and fluid pressure of the first hydraulic circuit and that of the second hydraulic circuit are thereby controlled (for example, see WO 2010/023985).

### SUMMARY OF THE INVENTION

In the above-described brake fluid pressure control unit, the inlet valves, the outlet valves, and the pressurizing/transferring mechanisms of the first hydraulic circuit and the second hydraulic circuit are provided in one base body. Accordingly, a brake fluid pipe from an input section (for example, the master cylinder attached to a handle bar) of the first hydraulic circuit, a brake fluid pipe from an output section (for example, the wheel cylinder of a front brake caliper) of the first hydraulic circuit, a brake fluid pipe from an input section (for example, the master cylinder attached to a foot pedal) of the second hydraulic circuit, and a brake fluid pipe from an output section (for example, the wheel cylinder of a rear brake caliper) of the second hydraulic circuit have to be arranged in an aggregated manner at one position in the motorcycle. As a result, arrangement length of each of the brake fluid pipes is increased, which possibly makes it difficult to secure a space in a body side of the motorcycle. In other words, the above-described fluid pressure control unit has such a problem that installability of the brake system in the motorcycle is low.

The invention has been made with the above-described problem as the background and therefore obtains a brake fluid pressure control unit that can improve installability of a brake system in a motorcycle. The invention also obtains a brake system for a motorcycle, the brake system including such a brake fluid pressure control unit.

A brake fluid pressure control unit according to the invention is a brake fluid pressure control unit of a brake system for a motorcycle. The brake system includes: a first hydraulic circuit that acts on a front wheel of the motorcycle; and a second hydraulic circuit that acts on a rear wheel of the motorcycle, and each of the first hydraulic circuit and the second hydraulic circuit includes: a primary channel that communicates between a master cylinder and a wheel cylinder; and a secondary channel that releases a brake fluid in said primary channel. The brake fluid pressure control unit includes: an inlet valve provided in each of the primary channel of the first hydraulic circuit and the primary channel of the second hydraulic circuit; an outlet valve provided in each of the secondary channel of the first hydraulic circuit and the secondary channel of the second hydraulic circuit; a pressurizing/transferring mechanism provided in each of a downstream side of the outlet valve in the secondary channel of the first hydraulic circuit and a downstream side of the outlet valve in the secondary channel of the second hydraulic circuit and pressurizing and transferring the brake fluid in each of said secondary channels; a first primary base body formed with a partial channel of the first hydraulic circuit therein and provided with the inlet valve and the outlet valve of the first hydraulic circuit; a first secondary base body formed with a partial channel of the first hydraulic circuit therein and provided with the pressurizing/transferring mechanism of the first hydraulic circuit; a second primary base body formed with a partial channel of the second hydraulic circuit therein and provided with the inlet valve and the outlet valve of the second hydraulic circuit; and a second secondary base body formed with a partial channel of the second hydraulic circuit therein and provided with the pressurizing/transferring mechanism of the second hydraulic circuit. The first primary base body, the first secondary base body, the second primary base body, and the second secondary base body are separated.

In addition, a brake system for a motorcycle according to the invention includes the brake fluid pressure control unit as described above.

In the brake fluid pressure control unit according to the invention, the inlet valve and the outlet valve of the first hydraulic circuit, the pressurizing/transferring mechanism of the first hydraulic circuit, the inlet valve and the outlet valve of the second hydraulic circuit, and the pressurizing/transferring mechanism of the second hydraulic circuit are provided to be respectively divided into the first primary base body, the first secondary base body, the second primary base body, and the second secondary base body that are separated. Accordingly, degrees of freedom in arrangement of a brake fluid pipe from an input section (for example, the master cylinder attached to a handle lever) of the first hydraulic circuit, a brake fluid pipe from an output section (for example, the wheel cylinder of a front brake caliper) of the first hydraulic circuit, a brake fluid pipe from an input section (for example, the master cylinder attached to a foot pedal) of the second hydraulic circuit, and a brake fluid pipe from an output section (for example, the wheel cylinder of a rear brake caliper) of the second hydraulic circuit are improved. Therefore, installability of the brake system in the motorcycle is improved.

### BRIEF DESCRIPTION OF THE DRAWINGS

FIG. 1 is a view of a system configuration of a brake system according to a first embodiment of the invention.

FIG. 2 is a view of an installed state of a brake fluid pressure control unit of the brake system according to the first embodiment of the invention in a motorcycle.

FIG. 3 is a view of a system configuration of a modified example of the brake system according to the first embodiment of the invention.

FIG. 4 is a view of a system configuration of a brake system according to a second embodiment of the invention.

FIG. 5 is a view of a system configuration of a brake system according to a third embodiment of the invention.

FIG. 6 is a view for explaining effects of the brake system according to the third embodiment of the invention.

### DETAILED DESCRIPTION

A description will hereinafter be made on a brake fluid pressure control unit and a brake system according to the invention by using the drawings.

Note that each of a configuration, an operation, and the like, which will be described below, is merely one example, and the brake fluid pressure control unit and the brake system according to the invention are not limited to a case with such a configuration, such an operation, and the like. There is a case where the same or similar members or portions are denoted by the same reference sign in each of the drawings. In addition, a detailed structure is depicted in an appropriately simplified manner or is not depicted.

### First Embodiment

A description will hereinafter be made on a brake system according to a first embodiment.

### <Configuration and Operation of the Brake System>

A description will be made on a configuration and an operation of the brake system according to the first embodiment.

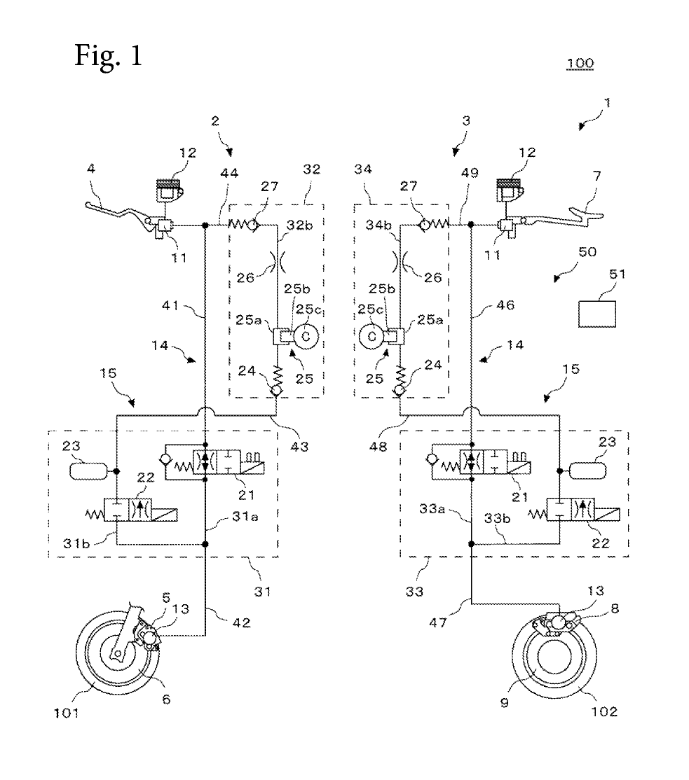

FIG. 1 is a view of a system configuration of the brake system according to the first embodiment of the invention.

As depicted in FIG. 1, a brake system 1 is installed in a motorcycle 100 (a two-wheeled motor vehicle or a three-wheeled motor vehicle) and includes: a first hydraulic circuit 2 that acts on a front wheel 101 of the motorcycle 100; and a second hydraulic circuit 3 that acts on a rear wheel 102 of the motorcycle 100. A brake fluid is filled in the first hydraulic circuit 2 and the second hydraulic circuit 3.

A piston (not depicted), which reciprocates in an interlocking manner with a handle lever 4, is incorporated in a master cylinder 11 of the first hydraulic circuit 2. A reservoir 12 is attached to the master cylinder 11. A wheel cylinder 13 of the first hydraulic circuit 2 is provided in a front brake caliper 5. When fluid pressure of the brake fluid in the wheel cylinder 13 is increased, a brake pad (not depicted) of the front brake caliper 5 is pressed against a front rotor 6 that rotates with the front wheel 101, and the front wheel 101 is thereby braked.

A piston (not depicted), which reciprocates in an interlocking manner with a foot pedal 7, is incorporated in a master cylinder 11 of the second hydraulic circuit 3. A reservoir 12 is attached to the master cylinder 11. A wheel cylinder 13 of the second hydraulic circuit 3 is provided in a rear brake caliper 8. When fluid pressure of the brake fluid in the wheel cylinder 13 is increased, a brake pad (not depicted) of the rear brake caliper 8 is pressed against a rear rotor 9 that rotates with the rear wheel 102, and the rear wheel 102 is thereby braked.

Each of the first hydraulic circuit 2 and the second hydraulic circuit 3 includes: a primary channel 14 that communicates between the master cylinder 11 and the wheel cylinder 13; and a secondary channel 15 that releases the brake fluid in the primary channel 14. An inlet valve 21 is provided in an intermediate section of the primary channel 14. The secondary channel 15 communicates between the wheel cylinder 13 side and the master cylinder 11 side of the inlet valve 21 in the primary channel 14 via an outlet valve 22. The inlet valve 21 is an electromagnetic valve that is opened in an unenergized state and is closed in an energized state, for example. The outlet valve 22 is an electromagnetic valve that is closed in the unenergized state and is opened in the energized state, for example.

An accumulator 23, a check valve 24, a pressurizing/transferring mechanism 25, a restrictor 26, and a check valve 27 are sequentially provided on a downstream side of the outlet valve 22 in the secondary channel 15. The check valve 24 limits a flow of the brake fluid from the pressurizing/transferring mechanism 25 toward the accumulator 23. The pressurizing/transferring mechanism 25 includes: a cylinder 25a; a piston 25b that reciprocates in the cylinder 25a; and a cam 25c that drives the piston 25b. The cam 25c is coupled to a power source (not depicted). The brake fluid is pressurized and transferred by reciprocal motion of the piston 25b that is associated with rotary drive of the cam 25c. The cam 25c of the first hydraulic circuit 2 and the cam 25c of the second hydraulic circuit 3 may be driven by a common power source or may be driven by different power sources. The restrictor 26 restricts an abrupt pressure increase of the brake fluid in the master cylinder 11. The check valve 27 limits a flow of the brake fluid from the master cylinder 11 side of the inlet valve 21 in the primary channel 14 toward the pressurizing/transferring mechanism 25. The check valve 24 corresponds to a “limiting mechanism” in the invention.

The inlet valve 21, the outlet valve 22, and the accumulator 23 of the first hydraulic circuit 2 are provided in a first primary base body 31 that is formed of: a partial channel 31a for constituting a part of the primary channel 14 of the first hydraulic circuit 2; and a partial channel 31b for constituting a part of the secondary channel 15 of the first hydraulic circuit 2. The check valve 24, the pressurizing/transferring mechanism 25, the restrictor 26, and the check valve 27 of the first hydraulic circuit 2 are provided in a first secondary base body 32 that is formed with a partial channel 32b for constituting a part of the secondary channel 15 of the first hydraulic circuit 2.

A brake fluid pipe 41 from the master cylinder 11 is connected to one end of the partial channel 31a in the first primary base body 31, and a brake fluid pipe 42 from the wheel cylinder 13 is connected to the other end thereof. One end of the partial channel 31b in the first primary base body 31 communicates with an intermediate section of the partial channels 31a, and an upstream end of a brake fluid pipe 43 is connected to the other end thereof. A downstream end of the brake fluid pipe 43 is connected to one end of the partial channel 32b in the first secondary base body 32, and a brake fluid pipe 44, which communicates with an intermediate section of the brake fluid pipe 41, is connected to the other end thereof.

The inlet valve 21, the outlet valve 22, and the accumulator 23 of the second hydraulic circuit 3 are provided in a second primary base body 33 that is formed of: a partial channel 33a for constituting a part of the primary channel 14 of the second hydraulic circuit 3; and a partial channel 33b afor constituting a part of the secondary channel 15 of the second hydraulic circuit 3. The check valve 24, the pressurizing/transferring mechanism 25, the restrictor 26, and the check valve 27 of the second hydraulic circuit 3 are provided in a second secondary base body 34 that is formed with a partial channel 34b for constituting a part of the secondary channel 15 of the second hydraulic circuit 3.

A brake fluid pipe 46 from the master cylinder 11 is connected to one end of the partial channel 33a in the second primary base body 33, and a brake fluid pipe 47 from the wheel cylinder 13 is connected to the other end thereof. One end of the partial channel 33b in the second primary base body 33 communicates with an intermediate section of the partial channels 33a, and an upstream end of a brake fluid pipe 48 is connected to the other end thereof. A downstream end of the brake fluid pipe 48 is connected to one end of the partial channel 34b in the second secondary base body 34, and a brake fluid pipe 49, which communicates with an intermediate section of the brake fluid pipe 46, is connected to the other end thereof.

Note that each of the ends on the wheel cylinder 13 side of the partial channel 31a in the first primary base body 31 and the partial channel 33a in the second primary base body 33 may directly be connected to the wheel cylinder 13, that is, without interposing the brake fluid pipe (the brake fluid pipes 42, 47) therebetween.

A brake fluid pressure control unit 50 is configured by at least including the first primary base body 31, the first secondary base body 32, the second primary base body 33, the second secondary base body 34, each member provided in each of those, and a controller 51 (an ECU). In the brake fluid pressure control unit 50, operations of the inlet valve 21 and the outlet valve 22 and the operation of the pressurizing/transferring mechanism 25 are controlled by the controller 51. In this way, the fluid pressure of the brake fluid in the wheel cylinder 13 is controlled.

The controller 51 may be provided as one unit or may be divided into plural units. For example, the controller 51 may be divided into a portion that controls the fluid pressure of the brake fluid in the first hydraulic circuit 2 and a portion that controls the fluid pressure of the brake fluid in the second hydraulic circuit 3. In addition, the controller 51 may be attached to the base body (the first primary base body 31, the first secondary base body 32, the second primary base body 33, the second secondary base body 34) or may be attached to another member. A part or a whole of the controller 51 may be constructed of a microcomputer, a microprocessor, or the like, for example, may be constructed of a member in which firmware and the like can be updated, or may be a program module or the like that is executed by a command from a CPU or the like.

The controller 51 executes the following fluid pressure control operation, for example.

In the case where locking or possible locking of a wheel (the front wheel 101, the rear wheel 102) of the motorcycle 100 is detected from a detection signal of a wheel rotation sensor (not depicted), for example, when the handle lever 4 or the foot pedal 7 of the motorcycle 100 is operated, the controller 51 initiates anti-lock brake control of the wheel.

Once initiating the anti-lock brake control, the controller 51 brings the inlet valve 21 into the energized state and blocks the primary channel 14, so as to limit the flow of the brake fluid from the master cylinder 11 to the wheel cylinder 13. In addition, the controller 51 brings the outlet valve 22 into the energized state and opens the secondary channel 15, so as to allow the flow of the brake fluid from the wheel cylinder 13 to the accumulator 23. Furthermore, the controller 51 drives the pressurizing/transferring mechanism 25 and thereby allows circulation of the brake fluid, which is accumulated in the accumulator 23, into the primary channel 14.

When cancellation of locking or avoidance of locking of the wheel (the front wheel 101, the rear wheel 102) of the motorcycle 100 is detected, the controller 51 brings each of the inlet valve 21 and the outlet valve 22 into the unenergized states and stops driving the pressuring/transferring mechanism 25, so as to terminate the anti-lock brake control.

<Installed state of the brake Fluid Pressure Control Unit in the Motorcycle>

A description will be made on an installed state of the brake fluid pressure control unit of the brake system according to the first embodiment in the motorcycle.

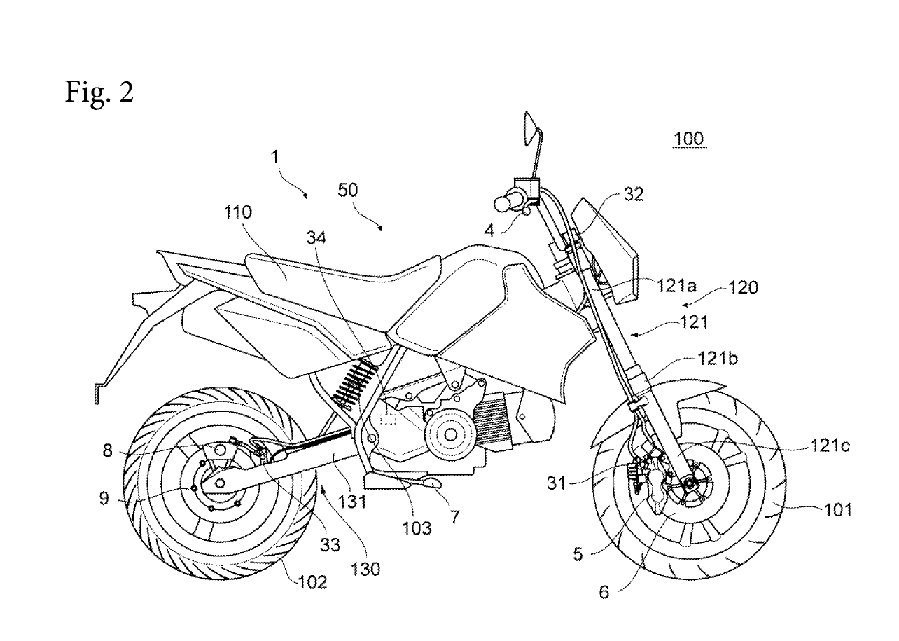

FIG. 2 is a view of the installed state of the brake fluid pressure control unit of the brake system according to the first embodiment of the invention in the motorcycle.

As depicted in FIG. 2, the motorcycle 100 includes: a trunk section 110; a turning section 120 that is turnably held by the trunk section 110 and holds the front wheel 101; and a coupling section 130 that couples the trunk section 110 and the rear wheel 102.

The turning section 120 includes a front fork 121 that is axially supported by the trunk section 110. The front fork 121 includes a front fork upper end 121a, a front suspension 121b, and a front fork lower end 121c. The front fork upper end 121a and the front fork lower end 121c are coupled via the front suspension 121b. In this way, the front fork 121 can be contracted/extended along an axis thereof. The front wheel 101 is axially supported by the front fork lower end 121c in a rotatable manner. In addition, the front brake caliper 5 is attached to the front fork lower end 121c. The brake pad (not depicted) of the front brake caliper 5 applies a friction force to the front rotor 6 that rotates with the front wheel 101.

The coupling section 130 includes a swing arm 131 that is axially supported by the trunk section 110 in a swingable manner. The other end of a rear suspension 103, one end of which is coupled to the trunk section 110, is coupled to an intermediate section of the swing arm 131. In addition, the rear brake caliper 8 is attached to a rear end of the swing arm 131. The brake pad (not depicted) of the rear brake caliper 8 applies the friction force to the rear rotor 9 that rotates with the rear wheel 102.

In other words, the turning section 120 is defined as a portion of the motorcycle 100 that turns with the front wheel 101, and includes the front fork 121. Meanwhile, the coupling section 130 is defined as a portion of the motorcycle 100 that couples the trunk section 110 and the rear wheel 102, and includes the swing arm 131. In addition, with the front suspension 121b being a reference, a portion on the trunk section 110 side of the turning section 120 is defined as a portion above a spring, and a portion on the front wheel 101 side thereof is defined as a portion below the spring. With a position at which the other end (that is, one end on a side that is not coupled to the trunk section 110) of the rear suspension 103 is coupled being a reference, a portion on the trunk section 110 side of the coupling section 130 is defined as a portion above a spring, and a portion on the rear wheel 102 side thereof is defined as a portion below the spring.

In the brake fluid pressure control unit 50 of the brake system 1, the first primary base body 31 is attached to the front brake caliper 5, and the second primary base body 33 is attached to the rear brake caliper 8. In addition, the first secondary base body 32 is attached to a member that constitutes a part of the turning section 120 (for example, a periphery of the handle lever 4, the front fork 121, or the like), and the second secondary base body 34 is attached to a member that constitutes a lower portion of the trunk section 110 (for example, a periphery of the foot pedal 7, a region between an engine and the swing arm 131, or the like). In other words, the first primary base body 31, the first secondary base body 32, the second primary base body 33, and the second secondary base body 34 are disposed at different positions in the motorcycle 100. Compared to the second primary base body 33 and the second secondary base body 34, the first primary base body 31 and the first secondary base body 32 are disposed in a front side of the motorcycle 100. The first primary base body 31 and the first secondary base body 32 are disposed in the turning section 120 of the motorcycle 100. The second primary base body 33 is disposed in the coupling section 130, and the second secondary base body 34 is disposed in the lower portion of the trunk section 110. The first primary base body 31 and the second primary base body 33 are disposed below the springs of the motorcycle 100.

Note that the plural base bodies (the first primary base body 31, the first secondary base body 32, the second primary base body 33, the second secondary base body 34) may be disposed in the vicinity in the motorcycle 100. In other words, the first primary base body 31, the first secondary base body 32, the second primary base body 33, and the second secondary base body 34 only need to be separated.

### <Effects of the Brake System>

A description will be made on effects of the brake system according to the first embodiment.

In the brake fluid pressure control unit 50 of the brake system 1, the first primary base body 31, the first secondary base body 32, the second primary base body 33, and the second secondary base body 34 are separated. Thus, degrees of freedom in arrangement of the brake fluid pipes 41, 44 from the master cylinder 11 of the first hydraulic circuit 2, the brake fluid pipe 42 from the wheel cylinder 13 of the first hydraulic circuit 2, the brake fluid pipes 46, 49 from the master cylinder 11 of the second hydraulic circuit 3, and the brake fluid pipe 47 from the wheel cylinder 13 of the second hydraulic circuit 3 are improved. Therefore, installability of the brake system 1 in the motorcycle 100 is improved.

In other words, in the brake fluid pressure control unit 50 of the brake system 1, the base bodies (the first primary base body 31, the first secondary base body 32) that are provided with the members for constituting the first hydraulic circuit 2, and the base bodies (the second primary base body 33, the second secondary base body 34) that are provided with the members for constituting the second hydraulic circuit 3 are separated from each other. In addition, the base body (the first primary base body 31, the second primary base body 33), which is provided with the inlet valve 21 and the outlet valve 22, and the base body (the first secondary base body 32, the second secondary base body 34), which is provided with the pressurizing/transferring mechanism 25, are separated from each other. Thus, the brake system 1 can be installed in a state as will be described below in the motorcycle 100.

For example, compared to the second primary base body 33 and the second secondary base body 34, the first primary base body 31 and the first secondary base body 32 can be disposed in the front side of the motorcycle 100. With such a configuration, arrangement length of each of the brake fluid pipes (the brake fluid pipes 41 to 44) in the first hydraulic circuit 2 is reduced, and arrangement length of each of the brake fluid pipes (the brake fluid pipes 46 to 49) in the second hydraulic circuit 3 is reduced. In this way, spaces that need to be secured in a body side of the motorcycle 100 can be reduced.

For example, the first primary base body 31 and the first secondary base body 32 can be disposed in the turning section 120 of the motorcycle 100. With such a configuration, the brake fluid pipes (the brake fluid pipes 41 to 44) of the first hydraulic circuit 2 can be arranged in the shortest route. Thus, the spaces that need to be secured in the body side of the motorcycle 100 can further be reduced.

For example, the second primary base body 33 can be disposed in the coupling section 130 of the motorcycle 100, and the second secondary base body 34 can be disposed in the lower portion of the trunk section 110 of the motorcycle 100. With such a configuration, the brake fluid pipes (the brake fluid pipes 46 to 49) of the second hydraulic circuit 3 can be arranged in the shortest route. Thus, the spaces that need to be secured in the body side of the motorcycle 100 can even further be reduced.

For example, the base body (the first primary base body 31, the second primary base body 33), which is provided with the inlet valve 21 and the outlet valve 22, can be disposed below the spring of the motorcycle 100. With such a configuration, some of the members (the inlet valve 21, the outlet valve 22) in each of the first hydraulic circuit 2 and the second hydraulic circuit 3 are disposed in a portion other than the trunk section 110 of the motorcycle 100. In this way, a space that needs to be secured in the trunk section 110 of the motorcycle 100 can be cut.

For example, the first secondary base body 32, which is downsized by separation from the first primary base body 31, and the second secondary base body 34, which is downsized by separation from the second primary base body 33, can be disposed in limited spaces of the motorcycle 100. In addition, a drive element (for example, the engine, the wheel, the power source of the suspensions, a starter motor, or the like) that is originally provided in the motorcycle 100 can serve as the power source of the pressurizing/transferring mechanism 25. With such a configuration, cost of the brake system 1 can be cut.

Note that a partial channel for constituting a part of the primary channel 14 is not formed in each of the first secondary base body 32 and the second secondary base body 34 in the brake fluid pressure control unit 50 of the brake system 1; therefore, even in the case where the first secondary base body 32 has to be disposed in a rear side of the motorcycle 100, where the second secondary base body 34 has to be disposed in the front side of the motorcycle 100, or the like, for example, the arrangement length of the brake fluid pipe (the brake fluid pipes 41, 46) from the master cylinder 11 can be reduced.

Preferably, in the brake fluid pressure control unit 50 of the brake system 1, the accumulator 23 and the check valve 24, which limits the flow of the brake fluid from the pressurizing/transferring mechanism 25 toward the accumulator 23, are sequentially connected between the outlet valve 22 and the pressurizing/transferring mechanism 25 in the secondary channel 15. Thus, an increase in the pressure of the brake fluid in the accumulator 23, which is caused by drive of the pressurizing/transferring mechanism 25, is suppressed. Therefore, durability, quietness, and the like are improved.

Preferably, in the brake fluid pressure control unit 50 of the brake system 1, the check valve 24 is provided in the base body (the first secondary base body 32, the second secondary base body 34), which is provided with the pressurizing/transferring mechanism 25. In the case where the check valve 24 is provided in the base body (the first primary base body 31, the second primary base body 33), which is provided with the inlet valve 21 and the outlet valve 22, the brake fluid pipe (the brake fluid pipes 43, 48) is interposed between the check valve 24 and the pressurizing/transferring mechanism 25, and thus length of the channel between the check valve 24 and the pressurizing/transferring mechanism 25 is increased. As a result, vacuuming between the check valve 24 and the pressurizing/transferring mechanism 25, which is conducted when the brake fluid is filled in the hydraulic circuits (the first hydraulic circuit 2, the second hydraulic circuit 3), possibly becomes difficult. On the contrary, in the case where the check valve 24 is provided in the base bodies (the first secondary base body 32, the second secondary base body 34), each of which is provided with the pressurizing/transferring mechanism 25, the length of the channel between the check valve 24 and the pressurizing/transferring mechanism 25 is reduced, and thus vacuuming between the check valve 24 and the pressurizing/transferring mechanism 25 can be realized by a simple process, such as of driving the pressurizing/transferring mechanism 25. Therefore, the installability of the brake system 1 in the motorcycle 100 is improved.

<Modified Example>

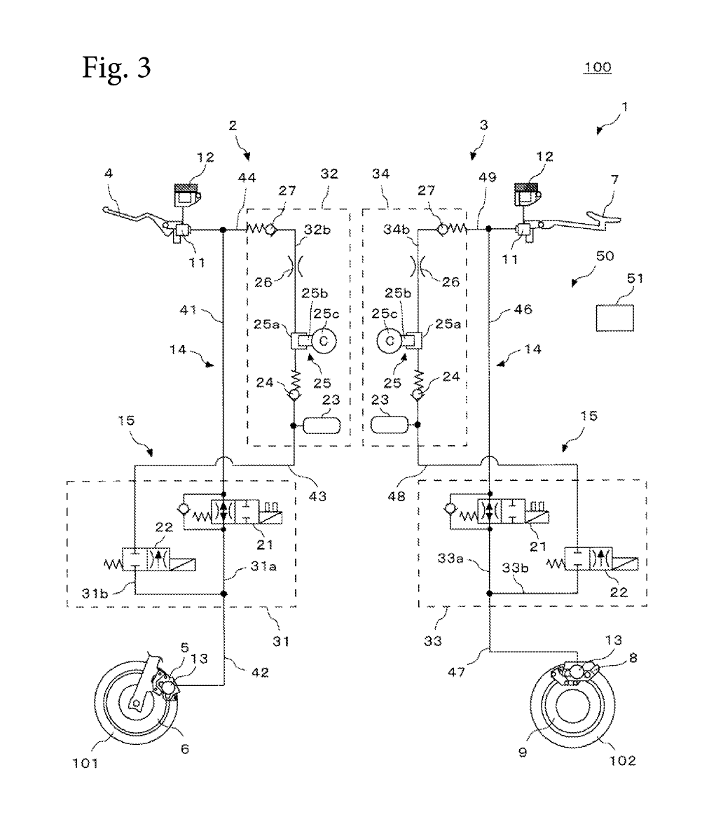

FIG. 3 is a view of a system configuration of a modified example of the brake system according to the first embodiment of the invention.

As depicted in FIG. 3, the accumulator 23 and the check valve 24 may be provided in the base body (the first secondary base body 32, the second secondary base body 34) that is provided with the pressurizing/transferring mechanism 25. In such a case, weight of the base body (the first primary base body 31, the second primary base body 33) that is provided with the inlet valve 21 and the outlet valve 22 can be reduced. In particular, in the cases where the base body (the first primary base body 31, the second primary base body 33) that is provided with the inlet valve 21 and the outlet valve 22 is disposed below the spring of the motorcycle 100 and the weight of the base body (the first primary base body 31, the second primary base body 33) that is provided with the inlet valve 21 and the outlet valve 22 is reduced, maneuverability of the motorcycle 100 is improved.

### Second Embodiment

A description will hereinafter be made on a brake system according to a second embodiment.

Note that the overlapping or similar description to that on the brake system according to the first embodiment will appropriately be simplified or omitted.

### <Configuration and Operation of the Brake System>

A description will be made on a configuration and an operation of the brake system according to the second embodiment.

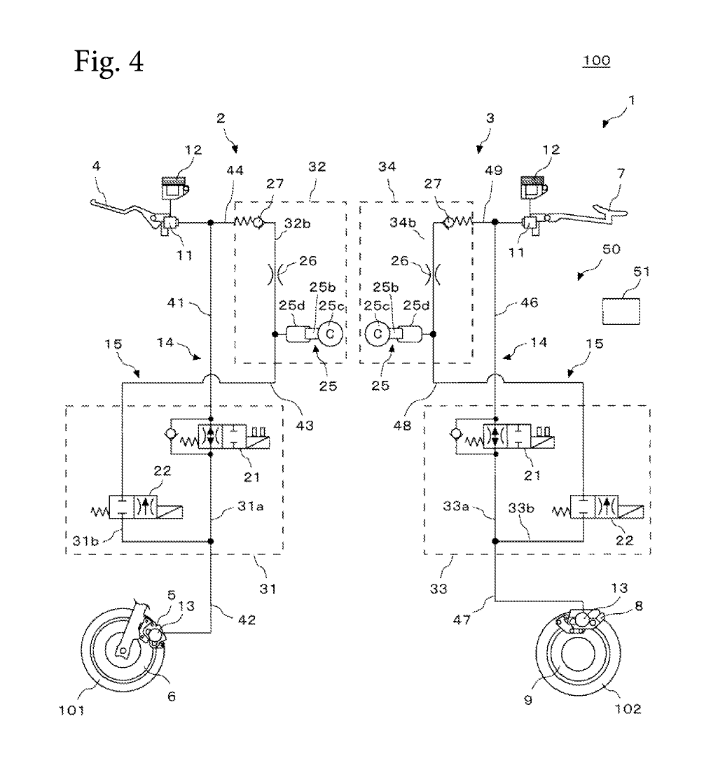

FIG. 4 is a view of a system configuration of the brake system according to the second embodiment of the invention.

As depicted in FIG. 4, the pressurizing/transferring mechanism 25, the restrictor 26, and the check valve 27 are sequentially provided on the downstream side of the outlet valve 22 in the secondary channel 15. The pressurizing/transferring mechanism 25 includes: an accumulator 25d; the piston 25b that reciprocates in the accumulator 25d; and the cam 25c that drives the piston 25b. The cam 25c is coupled to a power source (not depicted). When the cam 25c is rotationally driven by the drive source, a volume of the accumulator 25d that is defined by an inner wall of the accumulator 25d and an end surface of the piston 25b is reduced. In this way, the brake fluid is pressurized and transferred. In other words, the accumulator 23 and the check valve 24 depicted in FIG. 1 are not provided between the outlet valve 22 and the pressurizing/transferring mechanism 25 in the secondary channel 15, and the pressurizing/transferring mechanism 25 has a function of accumulating the brake fluid.

The controller 51 executes the following fluid pressure control operation, for example.

Once the anti-lock brake control is initiated, the controller 51 brings the inlet valve 21 into the energized state and blocks the primary channel 14, so as to limit the flow of the brake fluid from the master cylinder 11 to the wheel cylinder 13. In addition, the controller 51 brings the outlet valve 22 into the energized state and opens the secondary channel 15, so as to allow the flow of the brake fluid from the wheel cylinder 13 to the accumulator 25d. Furthermore, the controller 51 drives the pressurizing/transferring mechanism 25 after bringing the outlet valve 22 into the unenergized state and blocking the secondary channel 15, and thereby allows the circulation of the brake fluid, which is accumulated in the accumulator 25d, into the primary channel 14.

<Effects of the Brake System>

A description will be made on effects of the brake system according to the second embodiment.

Preferably, in the brake fluid pressure control unit 50 of the brake system 1, the pressurizing/transferring mechanism 25 of the secondary channel 15 reduces the volume of the accumulator 25d and thereby pressurizes and transfers the brake fluid. With such a configuration, the weight of the base body (the first primary base body 31, the second primary base body 33) that is provided with the inlet valve 21 and the outlet valve 22 can be reduced while enlargement of the base body (the first secondary base body 32, the second secondary base body 34) that is provided with the pressurizing/transferring mechanism 25 is suppressed. In particular, in the cases where the base body (the first primary base body 31, the second primary base body 33) that is provided with the inlet valve 21 and the outlet valve 22 is disposed below the spring of the motorcycle 100 and the weight of the base body (the first primary base body 31, the second primary base body 33) that is provided with the inlet valve 21 and the outlet valve 22 is reduced, the maneuverability of the motorcycle 100 is improved.

In addition, the check valve 24, which limits the flow of the brake fluid from the pressurizing/transferring mechanism 25 toward the outlet valve 22, no longer has to be interposed between the outlet valve 22 and the pressurizing/transferring mechanism 25. Thus, the number of components is cut. Furthermore, a region where vacuuming cannot be realized is not generated between the outlet valve 22 and the pressurizing/transferring mechanism 25. Thus, the process, such as of driving the pressurizing/transferring mechanism 25, does not have to be performed when the brake fluid is filled in the hydraulic circuit (the first hydraulic circuit 2, the second hydraulic circuit 3). Therefore, the installability of the brake system 1 in the motorcycle 100 is improved.

### Third Embodiment

A description will hereinafter be made on a brake system according to a third embodiment.

Note that the overlapping or similar description to those on the brake systems according to the first embodiment and the second embodiment will appropriately be simplified or omitted.

<Configuration and Operation of the Brake System>

A description will be made on a configuration and an operation of the brake system according to the third embodiment.

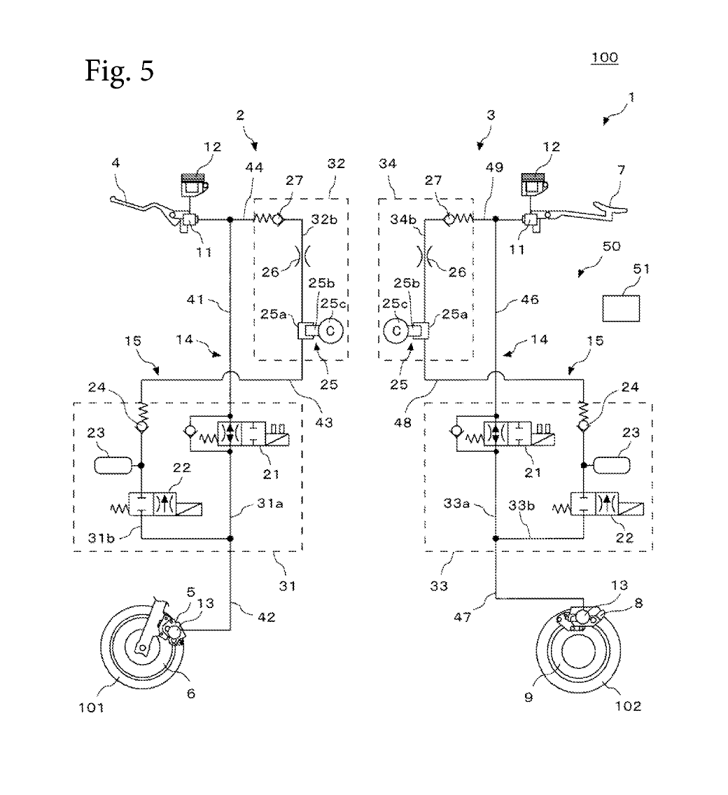

FIG. 5 is a view of a system configuration of the brake system according to the third embodiment of the invention.

As depicted in FIG. 5, the accumulator 23, the check valve 24, the pressurizing/transferring mechanism 25, the restrictor 26, and the check valve 27 are sequentially provided on the downstream side of the outlet valve 22 in the secondary channel 15. The inlet valve 21, the outlet valve 22, the accumulator 23, and the check valve 24 of the first hydraulic circuit 2 are provided in the first primary base body 31. The pressurizing/transferring mechanism 25, the restrictor 26, and the check valve 27 of the first hydraulic circuit 2 are provided in the first secondary base body 32. The inlet valve 21, the outlet valve 22, the accumulator 23, and the check valve 24 of the second hydraulic circuit 3 are provided in the second primary base body 33. The pressurizing/transferring mechanism 25, the restrictor 26, and the check valve 27 of the second hydraulic circuit 3 are provided in the second secondary base body 34.

<Effects of the Brake System>

A description will be made on effects of the brake system according to the third embodiment.

Preferably, in the brake fluid pressure control unit 50 of the brake system 1, the accumulator 23 and the check valve 24 are provided in the base body (the first primary base body 31, the second primary base body 33) that is provided with the outlet valve 22.

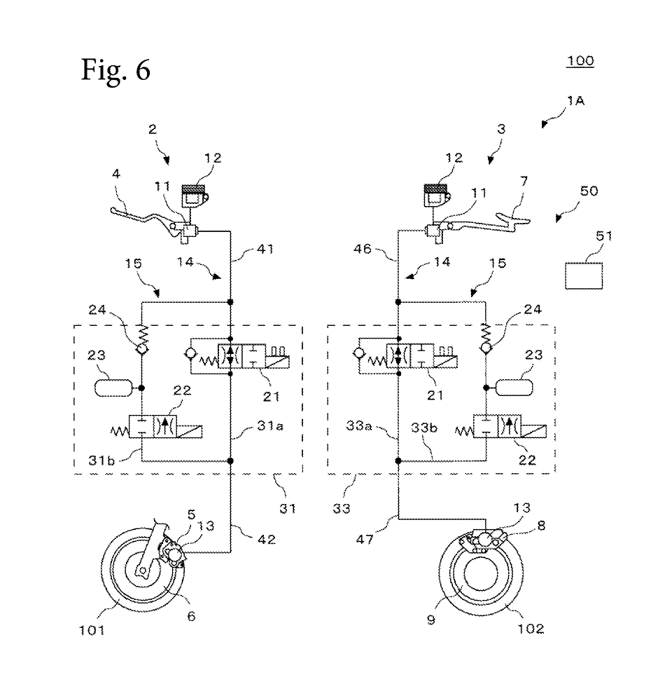

FIG. 6 is a view for explaining effects of the brake system according to the third embodiment of the invention.

With such a configuration, a brake system 1A of such a type that the pressurizing/transferring mechanism 25 as depicted in FIG. 3 is unnecessary, and the base body (the first primary base body 31, the second primary base body 33) that is provided with the outlet valve 22 can be commonalized. Thus, manufacturing cost, managing cost, and the like are cut.

The description has been made so far on the first embodiment to the third embodiment. However, the invention is not limited to the description of each of the embodiments. For example, only a part of each of the embodiments may be implemented, or all or parts of the embodiments may be combined.

### REFERENCE SIGNS LIST

1, 1A: Brake system
2: First hydraulic circuit
3: Second hydraulic circuit
4: Handle lever
5: Front brake caliper
6: Front rotor
7: Foot pedal
8: Rear brake caliper
9: Rear rotor
11: Master cylinder
12: Reservoir
13: Wheel cylinder
14: Primary channel
15: Secondary channel
21: Inlet valve
22: Outlet valve
23: Accumulator
24: Check valve
25: Pressurizing/transferring mechanism
25a: Cylinder
25b: Piston
25c: Cam
25d: Accumulator
26: Restrictor
27: Check valve
31: First primary base body
31a,31b: Partial channel
32: First secondary base body
32b: Partial channel
33: Second primary base body
33a, 33b: Partial channel
34: Second secondary base body
34b: Partial channel
41 to 44, 46 to 49: Brake fluid pipe
50: Brake fluid pressure control unit
51: Controller
100: Motorcycle
101: Front wheel
102: Rear wheel
103: Rear Suspension
110: Trunk section
120: Turning section
121: Front fork
121a: Front fork upper end
121b: Front suspension
121c: Front fork lower end
130: Coupling section
131: Swing arm

1. A brake fluid pressure control unit of a brake system for a motorcycle, the brake system including:
a first hydraulic circuit that acts on a front wheel of the motorcycle; and
a second hydraulic circuit that acts on a rear wheel of the motorcycle,
each of the first hydraulic circuit and the second hydraulic circuit including: a primary channel that communicates between a master cylinder and a wheel cylinder; and a secondary channel that releases a brake fluid in said primary channel,
the brake fluid pressure control unit comprising:
an inlet valve provided in each of the primary channel of the first hydraulic circuit and the primary channel of the second hydraulic circuit;
an outlet valve provided in each of the secondary channel of the first hydraulic circuit and the secondary channel of the second hydraulic circuit;
a pressurizing/transferring mechanism provided in each of a downstream side of the outlet valve in the secondary channel of the first hydraulic circuit and a downstream side of the outlet valve in the secondary channel of the second hydraulic circuit and pressurizing and transferring the brake fluid in each of said secondary channels;
a first primary base body formed with a partial channel of the first hydraulic circuit therein and provided with the inlet valve and the outlet valve of the first hydraulic circuit;
a first secondary base body formed with a partial channel of the first hydraulic circuit therein and provided with the pressurizing/transferring mechanism of the first hydraulic circuit;
a second primary base body formed with a partial channel of the second hydraulic circuit therein and provided with the inlet valve and the outlet valve of the second hydraulic circuit; and
a second secondary base body formed with a partial channel of the second hydraulic circuit therein and provided with the pressurizing/transferring mechanism of the second hydraulic circuit; wherein
the first primary base body, the first secondary base body, the second primary base body, and the second secondary base body are separated.

2. The brake fluid pressure control unit according to claim 1, wherein
an accumulator and a limiting mechanism that limits a flow of the brake fluid from the pressurizing/transferring mechanism toward said accumulator are sequentially connected between the outlet valve and said pressurizing/transferring mechanism in at least one of the secondary channel of the first hydraulic circuit and the secondary channel of the second hydraulic circuit.

3. The brake fluid pressure control unit according to claim 2, wherein
the limiting mechanism is provided in the secondary base body of the first secondary base body and the second secondary base body, the secondary base body being provided with the pressurizing/transferring mechanism in the secondary channel, to which said limiting mechanism is connected.

4. The brake fluid pressure control unit according to claim 3, wherein
the accumulator is provided in the secondary base body of the first secondary base body and the second secondary base body, the secondary base body being provided with the pressurizing/transferring mechanism in the secondary channel, to which said accumulator is connected.

5. The brake fluid pressure control unit according to claim 2, wherein
the accumulator and the limiting mechanism are provided in the primary base body of the first primary base body and the second primary base body, the primary base body being provided with the outlet valve of the secondary channel, to which said accumulator and said limiting mechanism are connected.

6. The brake fluid pressure control unit according to claim 1, wherein
the pressurizing/transferring mechanism in at least one of the secondary channel of the first hydraulic circuit and the secondary channel of the second hydraulic circuit reduces a volume of the accumulator and thereby pressurizes and transfers the brake fluid.

7. The brake fluid pressure control unit according to claim 6, wherein
the limiting mechanism, which limits the flow of the brake fluid from the pressurizing/transferring mechanism toward the outlet valve, is not interposed between said outlet valve and said pressurizing/transferring mechanism in the secondary channel, through which the brake fluid is pressurized and transferred by said pressurizing/transferring mechanism for reducing the volume of the accumulator.

8. The brake fluid pressure control unit according to claim 7 further comprising:
a controller for controlling operations of the inlet valve and the outlet valve and an operation of the pressurizing/transferring mechanism that reduces the volume of the accumulator, wherein
the controller drives the pressurizing/transferring mechanism, which reduces the volume of the accumulator, after closing the outlet valve of the secondary channel, through which the brake fluid is pressurized and transferred by said pressurizing/transferring mechanism.

9. The brake fluid pressure control unit according to claim 1, wherein,
compared to the second primary base body and the second secondary base body, the first primary base body and the first secondary base body are disposed in a front side of the motorcycle.

10. The brake fluid pressure control unit according to claim 9, wherein
the first primary base body and the first secondary base body are disposed in a turning section that turns with the front wheel of the motorcycle.

11. The brake fluid pressure control unit according to claim 9 or 10, wherein
the second primary base body is disposed in a coupling section that couples a trunk section and the rear wheel of the motorcycle, and
the second secondary base body is disposed in a lower portion of the trunk section of the motorcycle.

12. The brake fluid pressure control unit according to claim 1, wherein
at least one of the first primary base body and the second primary base body is disposed below a spring of the motorcycle.

13. The brake fluid pressure control unit according to claim 1, wherein
a power source of the pressurizing/transferring mechanism is at least one of an engine, the wheel, a power source of a suspension, and a starter motor.

14. A brake system for a motorcycle comprising:
the brake fluid pressure control unit according to claim 1.
